(19) United States
(12) Patent Application Publication
(10) Pub. No.: US 2019/0213615 A1
(43) Pub. Date: Jul. 11, 2019

(54) MARKET GEOGRAPHICAL AREA (MGA) BASED NOTIFICATION

(71) Applicant: INTERNATIONAL BUSINESS MACHINES CORPORATION, Armonk, NY (US)

(72) Inventors: Jeremy A. GREENBERGER, Raleigh, NC (US); Michael J. BORDASH, Newtown, CT (US)

(21) Appl. No.: 15/865,474

(22) Filed: Jan. 9, 2018

(51) Int. Cl. G06Q 30/02; G06F 15/18; G06N 5/02; H04W 68/00

(52) U.S. Cl. CPC G06Q 30/0205; G06Q 30/0201; H04W 68/005; G06N 5/02; G06F 15/18

(57) ABSTRACT

Methods, computer program products, and systems are presented. The method computer program products, and systems can include, for instance: obtaining a notification template for use in generating a notification for sending to a certain user, the notification template having a having a variable data content holder, wherein the variable data content holder specifies variable data content that varies based on a reference location for the certain user; examining, by machine logic, a location history of the user and based on the examining determining a reference location of the user; identifying, by machine logic, a market geographical area (MGA) region for the certain user based on the determined reference location of the certain user; and generating, by machine logic, a notification for sending to the certain user by filling in the variable data content holder of the notification template.

### BACKGROUND

Location based services (LBS) are software services that use location data to control functionality of computer systems. LBS information services have a number of uses, e.g. in social networking, entertainment, security, and in a plurality of additional applications. LBS services employ location services for locating mobile computer systems. Location services can incorporate a variety of different locating service technologies such as the Global Positioning System (GPS), cellular network locating technologies, and WiFi based locating technologies, and other technologies. One example of an LBS is a location based messaging services wherein notifications and other messages to users can be in dependence on the respective locations of the users.

Various service providers provide market geographical area (hereinafter “MGA”) based information such as MGA based market demographic data. MGA based demographic data can include data that is specified to relate to a certain MGA based region. Enterprise entities providing MGA based services include for example, comScore Networks, Experian PLC, and The Nielsen Company. The Nielsen Company provides MGA information for different MGAs regions. The Nielsen Company in its promotional literature refers to DESIGNATED MARKET AREA® or DMA® regions, and reports that there are two-hundred and ten (210) DMAs® in the United States. (Designated Market Area and DMA are registered trademarks of The Nielsen Company). An MGA information services provider can provide for each MGA region that it specifies such demographic information as median income in the MGA region, average family size within the MGA, and median age within the MGA.

### SUMMARY

Shortcomings of the prior art are overcome, and additional advantages are provided, through the provision, in one aspect, of a method. The method can include, for example: obtaining a notification template for use in generating a notification for sending to a certain user, the notification template having a having a variable data content holder, wherein the variable data content holder specifies variable data content that varies based on a reference location for the certain user; examining, by machine logic, a location history of the user and based on the examining determining a reference location of the user; identifying, by machine logic, a market geographical area (hereinafter “MGA”) region for the certain user based on the determined reference location of the certain user; generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and sending the generated notification to the certain user.

In another aspect, a computer program product can be provided. The computer program product can include a computer readable storage medium readable by one or more processing unit and storing instructions for execution by one or more processor for performing a method. The method can include, for example: obtaining a notification template for use in generating a notification for sending to a certain user, the notification template having a having a variable data content holder, wherein the variable data content holder specifies variable data content that varies based on a reference location for the certain user; examining, by machine logic, a location history of the user and based on the examining determining a reference location of the user; identifying, by machine logic, a market geographical area (MGA) region for the certain user based on the determined reference location of the certain user; generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and sending the generated notification to the certain user.

In a further aspect, a system can be provided. The system can include, for example a memory. In addition, the system can include one or more processor in communication with the memory. Further, the system can include program instructions executable by the one or more processor via the memory to perform a method. The method can include, for example: obtaining a notification template for use in generating a notification for sending to a certain user, the notification template having a having a variable data content holder, wherein the variable data content holder specifies variable data content that varies based on a reference location for the certain user; examining, by machine logic, a location history of the user and based on the examining determining a reference location of the user; identifying, by machine logic, a market geographical area (MGA) region for the certain user based on the determined reference location of the certain user; generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and sending the generated notification to the certain user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having market geographical area (MGA) based notification system for sending notifications to users according to one embodiment;

FIG. 2 is flowchart illustrating a method that can be performed by an MGA based notification system according to one embodiment;

FIG. 3 depicts an administrator user interface according to one embodiment;

FIG. 4 depicts a notification according to one embodiment;

FIG. 5 depicts a notification according to one embodiment;

FIG. 6 depicts a computing node according to one embodiment;

FIG. 7 depicts a cloud computing environment according to one embodiment; and

FIG. 8 depicts abstraction model layers according to one embodiment.

### DETAILED DESCRIPTION

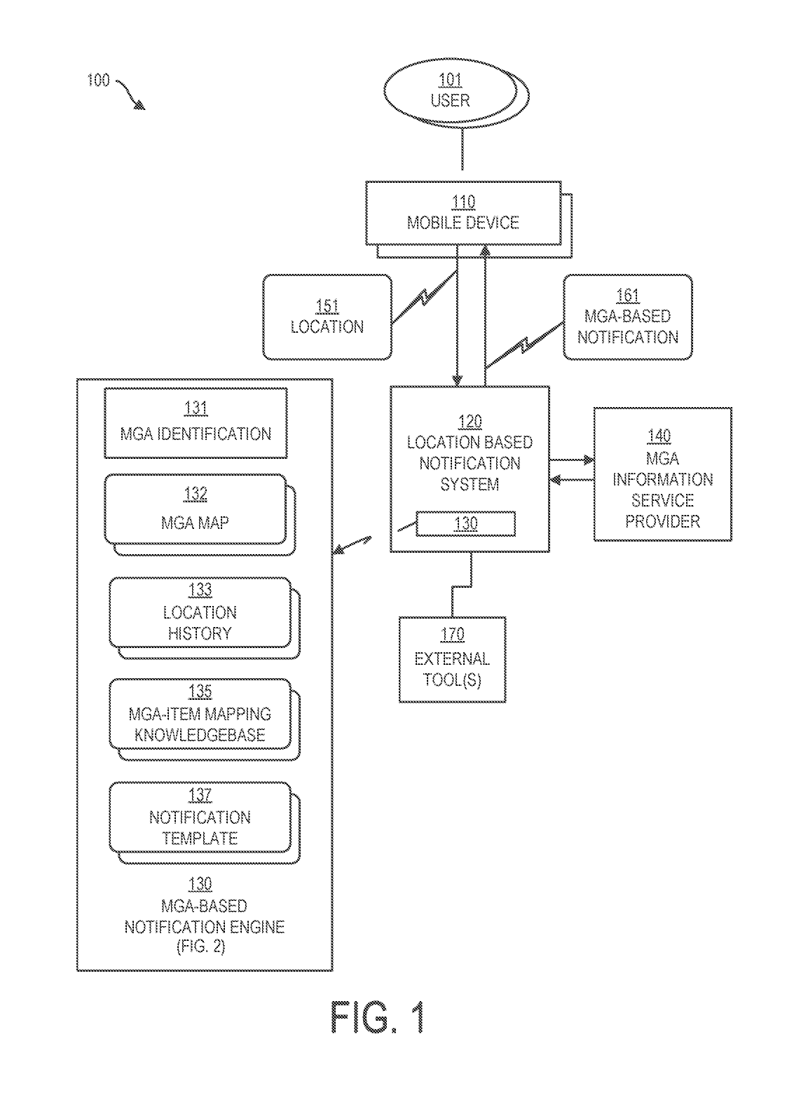

FIG. 1 depicts a system 100 for providing notifications for users in an environment. System 100 can provide augmented notifications to users based on determined demographic information of the users. While processes performed by system 100 can employ analytics and use of history data, as well as machine learning the processes are lightweight, and can be employed even where limited data is available for a user such as in the case that the user may be a new subscriber to a service that features a location based notification system.

System 100 can include a mobile device 110, e.g. a smartphone, that is used by a user 101, as well as a location based notification system 120 that is in communication with mobile device 110. Mobile device 110 can iteratively provide location information 151 to location based notification system 120.

Over the course of its deployment, location based notification system 120 can provide notifications to users such as user 101 of mobile device 110. In one example, location based notification system 120 supports a promotional program that is organized by an enterprise, e.g. a retail store enterprise or restaurant enterprise. Location based notification system 120 may be used to provide notifications, e.g. regarding promotions to subscribers of services provided by the enterprise.

Location based notification system 120 can include an MGA based notification engine 130. MGA based notification engine 130 can be run to cognitively generate and send notifications to users such as user 101.

Location based notification system 120 can be in communication with MGA information service provider 140. MGA information service provider 140 can provide various market geographical area (MGA) information such as demographic information. Enterprises that provide MGA information include such entities as comScore Networks, Experian PLC, and The Nielsen Company. From time to time, location based notification system 120 can request and receive updated MGA based demographic information from MGA information service provider 140. In some embodiments, location based notification system 120 can make requests of MGA information service provider 140 on demand, when generating a notification. MGA based demographic information can include such information as the median income within an MGA region, the average family size within an MGA, and the median age within an MGA.

Location based notification system 120 can be in communication with external tools 170. Examples of external tools 170 may include but are not limited to a machine learning process, IBM WATSON® Rank and Retrieve service and other tools (IBM WATSON® is a registered trademark of International Business Machines Corporation).

MGA based notification engine 130 can run various processes and can store various data. MGA based notification engine 130 can run MGA identification process 131 and can store in a data storage area of location based notification system 120, MGA map 132, MGA-item mapping knowledgebase 135, and notification template 137. MGA based notification engine 130, running MGA identification process 131 can determine an MGA region of a user based on an examining of location history of the user and based on map data of MGA map 132.

MGA based notification engine 130 can also store in a storage location of location based notification system 120 a location history 133 of various users of system 100. For example, users of system 100 can be subscriber users of a service provided by an enterprise that provides location based notification system 120. In exchange for benefits associated with a provided service users may permit location based notification system 120 to store location history of the various users which location history 133 can be stored in a storage area of location based notification system 120.

MGA-item mapping knowledgebase 135 maps MGA based demographic conditions to content items such as text content items that may be referenced in a notification. In one embodiment, MGA-item mapping knowledgebase 135 can be provided by cognitive decision table in which a decision to select a certain content item e.g. text content item for referencing in a notification is fired based on multiple demographic conditions being satisfied (which demographic conditions can be based on and can be associated to a determined MGA region). The demographic conditions that apply to a user for whom a notification is being generated can be demographic conditions obtained from an MGA information service provider 140 based on a determined MGA region determined for the user.

In one embodiment, a decision to select a certain content item for referencing in a notification can be fired based on median income being within a certain range, average family size being within another certain range, and median age being within another certain range. MGA based notification engine 130 can determine an MGA region for a user based on a reference location for a user matching an MGA region on MGA map 132. MGA map 132 can specify different MGA regions and each of the different regions can have an associated identifier.

According to one example, MGA based notification engine 130 running MGA identification process 131 can determine based, on an examining of data of location history 133 of a user, that a user has a reference location of San Jose, Calif., and can further determine using MGA map 132 provided by an MGA information service provider 140 that San Jose, Calif. is within the MGA region identified as 001 by the MGA information services provider 140. MGA based notification engine 130, running notification process 131 can then obtain demographic information associated with the MGA identifier 001 as specified in the demographic data provided by the MGA information services provider 140 for the MGA region identified by the identifier 001.

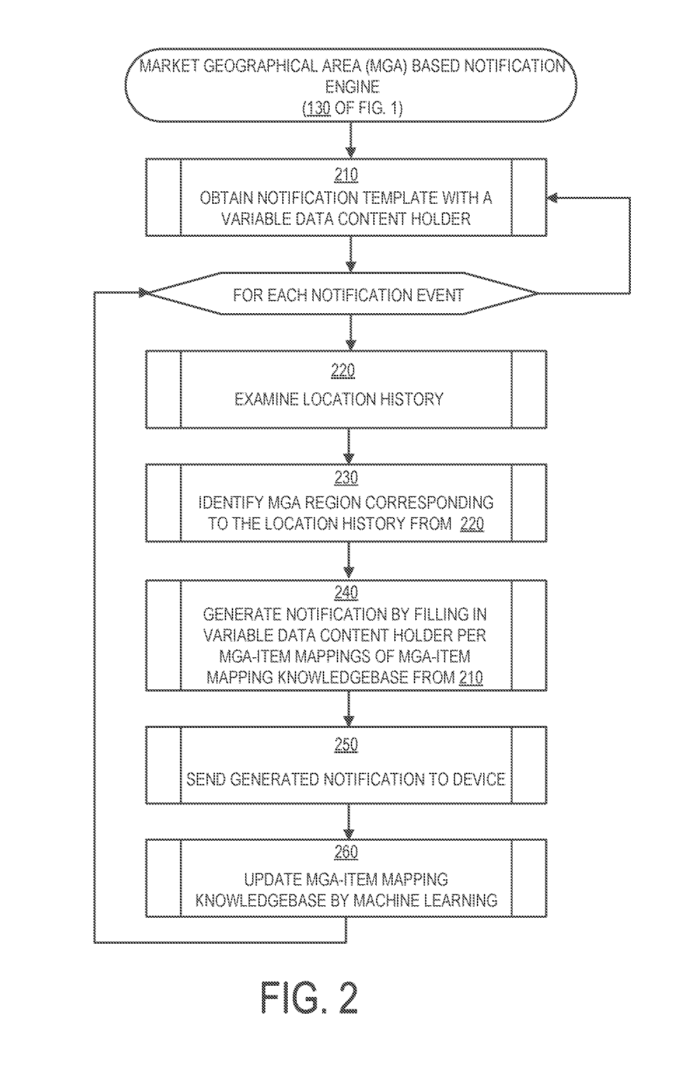

FIG. 2 depicts a flowchart of operations performed by MGA based notification engine 130 in accordance with one or more embodiments set forth herein.

At block 210 MGA based notification engine 130 obtains notification template 137 which can be stored in a storage area of location based notification system 120. The notification template 137 obtained at block 210 can be a notification template with a variable data content holder. The variable data content holder can be an area, e.g. a text field or another spatial area of the notification template reserved for filling in, based on a determined MGA region of the user to whom the notification obtained at block 210 is designated for sending.

At block 220 MGA based notification engine 130 can examine location history of the user for whom a notification is being generated by MGA based notification engine 130. At block 230 MGA based notification engine 130 can identify an MGA region for the user corresponding to the location history of the user examined at block 220. For determining an MGA region for the user at block 230, MGA based notification engine 130 can determine an MGA for the user based on one or more reference location for the user. The one or more reference location for the user can be determined based on an examining of location history of the user at block 220. A reference location for a user can include, e.g. the user's home location or the user's office location. MGA based notification engine 130 at block 220 can determine these reference locations by examining location history data of the user. For example, if the location history data of the user exhibits a trend wherein the user consistently spends the evening hours, e.g. from 6:00 pm to 6:00 am at a first location and weekday daytime hours 8:00 am to 5:00 pm at a second location, MGA based notification engine 130 can determine with a threshold exceeding level of confidence that the first location is the user's home location and the second location is the user's office location.

MGA based notification engine 130 at block 230 with a reference location of a user determined at block 220, can use MGA map 132 (FIG. 1) to determine an MGA region for the user based on a reference location of the user (e.g. the determined home location or office location). For example, at block 230 MGA based notification engine 130 can determine that the home reference location of the user is associated to MGA region 001 as defined by an MGA information services provider 140. Thus, MGA based notification engine 130 can identify MGA region 001 as the MGA region for the user for whom a notification is being generated.

At block 240 MGA based notification engine 130 can generate a notification to the user by filling in the variable data content holder of the notification template 137 (block 210) per MGA-item mappings of MGA-item mapping knowledgebase 135 (FIG. 1). MGA-item mapping knowledgebase 135 can map for example MGA based demographic information to notification to decisions for filing selection of specified notification content. Table 1 as set forth below illustrates an MGA-item mapping knowledgebase 135 (FIG. 1) in one embodiment.

TABLE 1

| Median Income | | | |
|---|---|---|---|
| Range | Average Family Size Range | Median Age Range | Item |
| 1 | 1 | 1 | A |
| 2 | 1 | 2 | B |
| 1 | 2 | 2 | A |
| 1 | 3 | 1 | A |
| 2 | 4 | 2 | C |
| 1 | 3 | 3 | B |
| 2 | 2 | 2 | B |
| . | . | . | . |
| . | . | . | . |
| . | . | . | . |

The ranges can be ranges obtained based on information received from an MGA information services provider 140, based on the identified MGA region of the user identified at block 230 (FIG. 2). In Table 1 limited example rows of data are shown; however, it is understood that the table can include hundreds or even thousands of rows depending on the permutations of possible conditions and notification program design decisions. Based on the determined MGA region of the user determined at block 230, MGA based notification engine 130 at block 240 can obtain demographic data associated to an MGA region for a user for whom a notification is being generated and can perform comparing such obtained demographic data to demographic data that is specified as firing condition demographic data in MGA-item mapping knowledgebase 135 e.g. in accordance with Table 1.

MGA based notification engine 130 can fire a notification content selection decision associated to a certain row based on all of the conditions specified in a certain row of Table 1 being determined to be satisfied based on the noted comparing of obtained demographic data associated to an MGA region and the demographic data firing conditions specified in MGA-item mapping knowledgebase 135. Based on a decision firing condition being observed, MGA based notification engine 130 can select the notification content item specified in the fired row as the item for filling in the variable data content holder of the notification template 137 (block 210). At block 250, MGA based notification engine 130 can send the generated notification generated at block 240 to mobile device 110 for receipt by mobile device 110 and access by user 101.

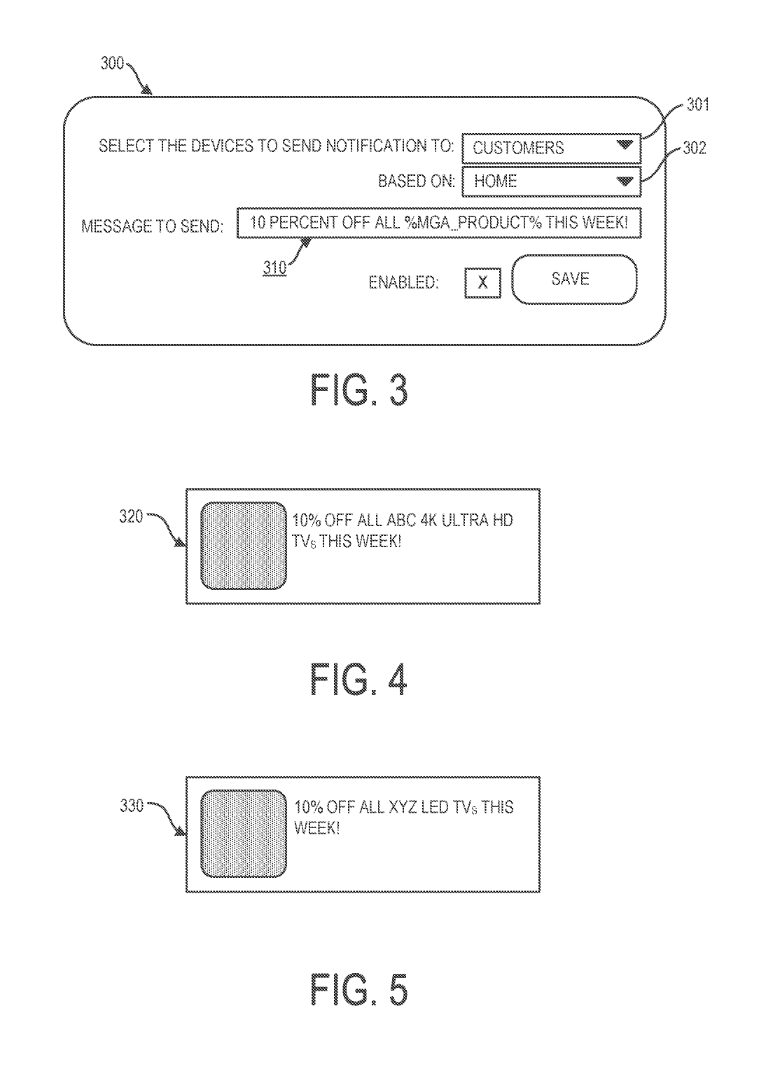

In FIG. 3 there is an exemplary administrator user interface 300. An administrator user can use administrator user interface 300 to configure notification templates, such as notification template 137, for use in generating notifications for sending to users. In area 301, an administrator user can select the devices to whom the notification will be sent. For example, in area 301 an administrator user can select the group “customers” or other groups, for example “employees” e.g. employees of the enterprise providing location based notification system 120. In area 302, an administrator user can define configuration data that specifies a criterion for the determining of reference location of a user based on an examining of a location history of a user. For example, if “home” is selected using area 302, MGA based notification engine 130 can select and determine home location of a user as the user's reference location and if “office” is designated in area 302 MGA based notification engine 130 at block 230, can select and determine a user's office location as the reference location of the user.

In area 310, an administrator user can specify using e.g. markup language text data defining a notification template with the variable data content holder (block 210). In the example described with reference to administrator user interface 300, area 310 specifies the content between the pair of percentage symbols, “%”, as the variable data area. With the variable data area specified, MGA based notification engine 130 is enabled to fill in the missing data of the variable data content holder using an appropriate MGA-item mapping knowledgebase 135 (FIG. 1).

FIGS. 4 and 5 respectively depict different notifications that can be sent to different users during first and second respective iterations according to the operations depicted in the flowchart of FIG. 2. FIG. 4 depicts a promotional notification in which higher cost TVs are specified and FIG. 5 depicts a notification in which lower cost TVs are specified. The notification 320 illustrated in FIG. 4 may be based on a determination that a reference location of a user is a first location that is specified to be within a first MGA region and notification 330 depicted in FIG. 5 can be generated and sent based on a determination that a reference location for a user designated for receiving notification 330 is a second MGA region.

Referring to an MGA-item mapping knowledgebase 135, e.g. as depicted in Table 1, the MGA region classification MGA region=MGA region 001 can generate a first firing condition based on the obtained particular demographic range conditions associated to MGA region 001 and second MGA region classification MGA region=MGA region 002 can generate a second firing condition based on the obtained particular demographic range conditions associated to MGA region 002.

As set forth in reference to Table 1, MGA-item mapping knowledgebase 135 can be established so that different notifications can be generated, e.g. specifying higher cost TVs or lower cost TVs based on median income range and in some embodiments one or more additional conditions such as average family size range and median age range although any set of one or more condition can be specified by an administrator to satisfy any notification objective associated with the notification program.

Referring again to the flowchart of FIG. 2, MGA based notification engine 130 at block 260 can update MGA-item knowledgebase 135 by machine learning. For performance of updating by machine learning at block 260, MGA based notification engine 130 can monitor performance of notifications, e.g. can monitor results associated with notifications after notifications are generated and sent at block 250. Based on the monitoring MGA based notification engine 130 can make modifications to an MGA-item mapping knowledgebase 135, such as that depicted in Table 1.

For example, in one embodiment, MGA based notification engine 130 can retain notification content specified in the “item” column of Table 1 based on a result associated with monitoring indicating that the notification was successful, e.g. that the user engaged in the conduct targeted to be induced by a notification. On the other hand, based on a result of a monitoring indicating that a notification was not successful (as indicated by the user not engaging in the activity targeted to be induced by the notification) MGA based notification engine 130 at block 250 can discard content specified by the “item” column of Table 1 and replace the content with alternative content, e.g. as may be specified in a predetermined list. MGA-item mapping knowledgebase 135 is thereby enabled by machine learning to adapt its cognitive decisions over time so that cognitive decisions performed by MGA based notification engine 130 become more reliable and accurate as the iterations of performed notification generation processes increase.

Certain embodiments herein may offer various technical computer advantages. A fundamental aspect of the operation of a computer network its interfacing with external entities which can include machine entities or human entities. Accordingly, in one aspect, improved computing processes featuring artificial intelligence (AI) platforms are provided that increase relevancy and accuracy of notifications to users, thus improving interactions between computer network and a user, and increasing the likelihood of a human user remaining engaged in interactions that are driven by the computer network. Embodiments herein can feature use of a market geographical area (MGA)-item mapping knowledgebase that specifies content for filling in a notification template that includes a variable data content holder. Location history data of a user can be examined and based on a result of the examining and determining a location reference for the user an MGA region for the user can be identified. Cognitive decisions can be provided with use of the MGA-item mapping knowledgebase that are responsive to a determined MGA region associated to a user. Cognitive decision with use of an MGA-item mapping knowledgebase can be provided with machine learning functionality so that cognitive decisions facilitated with use of MGA-item mapping knowledgebase become more accurate and reliable over time as iterations of performed notification generation processes increase.

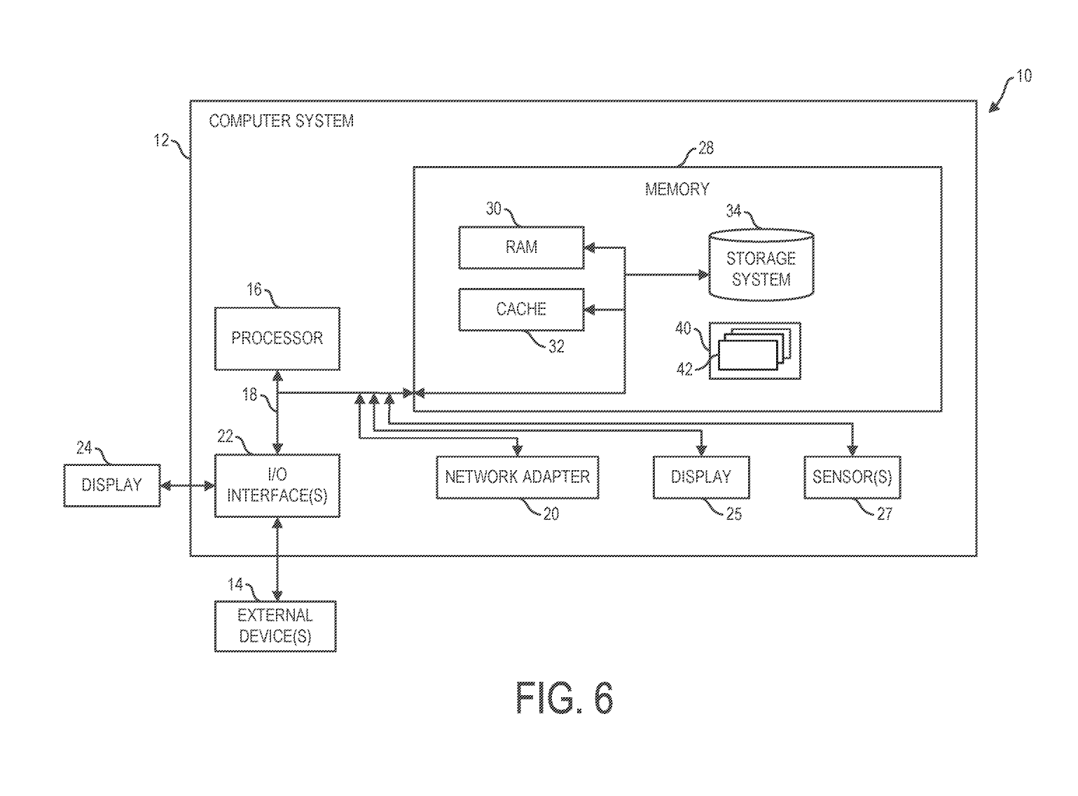

FIGS. 6-8 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

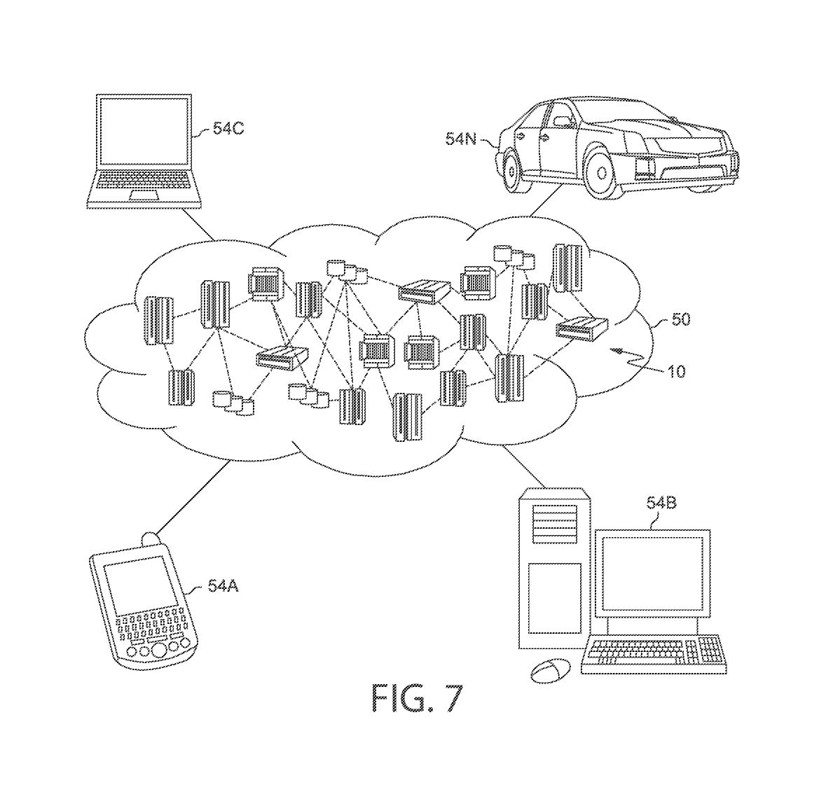

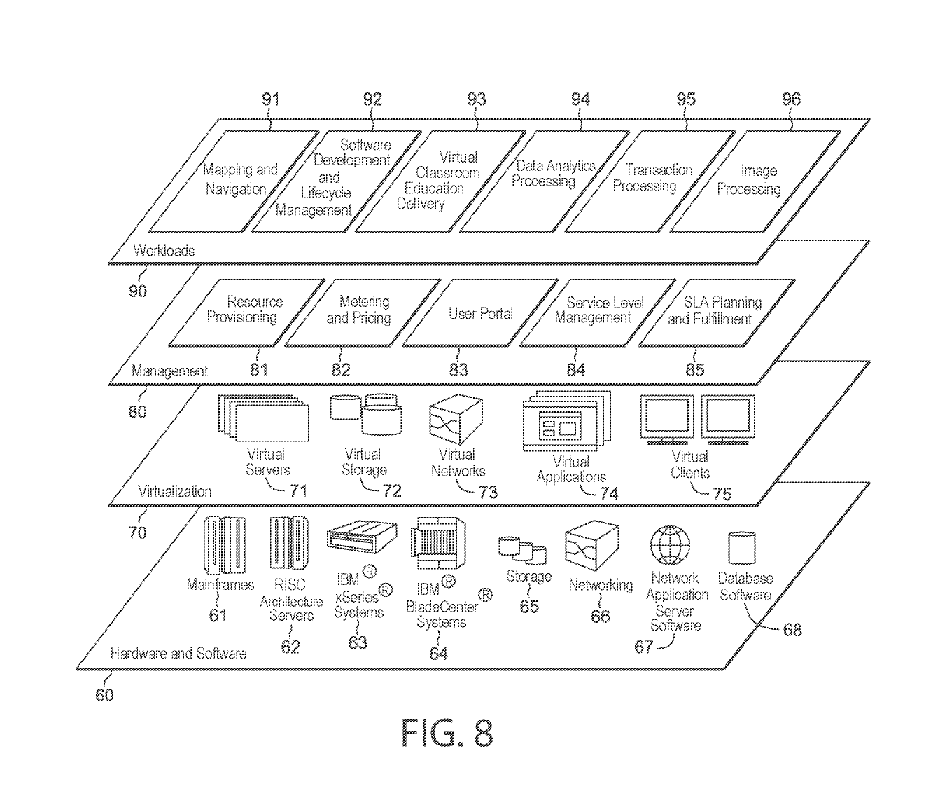

As shown in FIG. 6, computer system 12 in computing node 10 is shown. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 7-8.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein. In one embodiment, MGA-based notification engine 130 can include one or more computing node 10 and can include one or more program 40 for performing functions described with reference to method of FIG. 2. In one embodiment, the various computing node based devices and systems of FIG. 1 can include one or more program for performing their associated described functionalities.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18. In one embodiment, display 25 can be configured as a touch screen display and can be configured to provide user interface functionality, e.g. can facilitate virtual keyboard functionality and input of total data. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., one or more of a camera, a gyroscope, a temperature sensor, a humidity sensor, a pulse sensor, a heartrate sensor, a blood pressure (bp) sensor or an audio input device. Computer system 12 can include one or more network adapter 20. In FIG. 7 computing node 10 is described as being implemented in a cloud computing environment and accordingly is referred to as a cloud computing node in the context of FIG. 7.

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for specified notification generation and associated processes as set forth herein. The processing components 96 can be implemented with use of one or more program 40 described in FIG. 6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method comprising:
obtaining a notification template for use in generating a notification for sending to a certain user, the notification template having a variable data content holder, wherein the variable data content holder specifies variable data content that varies based on a reference location for the certain user;
examining, by machine logic, a location history of the user and based on the examining determining a reference location of the user;
identifying, by machine logic, a market geographical area (MGA) region for the certain user based on the determined reference location of the certain user;
generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and
sending the generated notification to the certain user.

2. The method of claim 1, wherein the examining, by machine logic, a location history of the user includes determining a reference location selected from the group consisting of a home location of the certain user and an office location of the certain user.

3. The method of claim 1, wherein the data determined based on the identified MGA region for the certain user includes demographic data, wherein the demographic data includes data selected from the group consisting of median income, median number of children, and median age range.

4. The method of claim 1, wherein the method includes updating the MGA-item mapping knowledgebase by machine learning.

5. The method of claim 1, wherein the data determined based on the identified MGA region for the certain user includes demographic data, and wherein the demographic data includes median income data.

6. The method of claim 1, wherein the data determined based on the identified MGA region for the certain user includes demographic data, wherein the demographic data includes median income data, and wherein the method includes receiving the demographic data from an MGA information service provider based on the identified MGA region for the certain user.

7. The method of claim 1, wherein the notification template includes text based notification content and wherein a position of the variable data content holder within the text based notification template is based on configuration defined by an administrator user using an administrator user interface.

8. The method of claim 1, wherein the method includes an administrator user entering marked up language text into an administrator user interface to specify attributes of the notification template.

9. The method of claim 1, wherein the determining a reference location of the user includes determining a reference location of the user based on configuration data entered into an administrator user using an administrator user interface, wherein the configuration entered into the administrator user interface specifies that the user's home location is the reference location of the user and wherein the examining, by machine logic, a location history of the user includes examining the location history to determine a location of the user's home location.

10. The method of claim 1, wherein the determining a reference location of the user includes determining a reference location of the user based on configuration data entered into an administrator user using an administrator user interface, wherein the configuration entered into the administrator user interface specifies that the user's office location is the reference location of the user and wherein the examining, by machine logic, a location history of the user includes examining the location history to determine a location of the user's office location.

11. The method of claim 1, wherein the method includes monitoring a performance of the notification and updating the MGA-item mapping knowledgebase by machine learning based on the monitoring.

12. A computer program product comprising:
a computer readable storage medium readable by one or more processing circuit and storing instructions for execution by one or more processor for performing a method comprising:
obtaining a notification template for use in generating a notification for sending to a certain user, the notification template having a variable data content holder, wherein the variable data content holder specifies variable data content that varies based on a reference location for the certain user;
examining, by machine logic, a location history of the user and based on the examining determining a reference location of the user;
identifying, by machine logic, a market geographical area (MGA) region for the certain user based on the determined reference location of the certain user;
generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and
sending the generated notification to the certain user.

13. The computer program product of claim 12, wherein the examining, by machine logic, a location history of the user and based on the examining determining a reference location of the user includes determining a reference location selected from the group consisting of a home location of the certain user and an office location of the certain user, wherein the data determined based on the identified MGA region for the certain user includes demographic data, wherein the demographic data includes data selected from the group consisting of median income, median number of children, and median age range.

14. The computer program product of claim 12, wherein the method includes updating the MGA-item mapping knowledgebase by machine learning.

15. The computer program product of claim 12, wherein the data determined based on the identified MGA region for the certain user includes demographic data, and wherein the demographic data includes median income data.

16. The computer program product of claim 12, wherein the data determined based on the identified MGA region for the certain user includes demographic data, wherein the demographic data includes median income data, and wherein the method includes receiving the demographic data from an MGA information service provider based on the identified MGA region for the certain user, and wherein the notification template includes a text based notification content and wherein a position of the variable data content holder within the text based notification template is based on configuration defined by an administrator user using an administrator user interface.

17. The computer program product of claim 12, wherein the method includes an administrator user entering marked up language text into an administrator user interface to specify attributes of the notification template, wherein the determining a reference location of the user includes determining a reference location of the user based on configuration data entered into an administrator user using an administrator user interface, wherein the configuration entered into the administrator user interface specifies that the user's home location is the reference location of the user and wherein the examining, by machine logic, a location history of the user includes examining the location history to determine a location of the user's home location.

18. The computer program product of claim 12, wherein the determining a reference location of the user includes determining a reference location of the user based on configuration data entered into an administrator user using an administrator user interface, wherein the configuration data entered into the administrator user interface specifies that the user's office location is the reference location of the user and wherein the examining, by machine logic, a location history of the user includes examining the location history to determine a location of the user's office location.

19. The computer program product of claim 12, wherein the method includes monitoring a performance of the notification and updating the MGA-item mapping knowledgebase by machine learning based on the monitoring.

20. A system comprising:
a memory;
at least one processor in communication with memory; and
program instructions executable by one or more processor via the memory to perform a method comprising:
obtaining a notification template for use in generating a notification for sending to a certain user, the notification template having a variable data content holder, wherein the variable data content holder specifies variable data content that varies based on a reference location for the certain user;
examining, by machine logic, a location history of the user and based on the examining determining a reference location of the user;
identifying, by machine logic, a market geographical area (MGA) region for the certain user based on the determined reference location of the certain user;
generating, by machine logic, a notification for sending to the certain user by filling in the variable data content holder of the notification template, wherein content for use in performing the filling is determined using an MGA-item mapping knowledgebase that maps data determined based on the identified MGA region for the certain user to notification content items; and
sending the generated notification to the certain user.
